(19) United States
(12) Patent Application Publication
(10) Pub. No.: US 2014/0025255 A1
(43) Pub. Date: Jan. 23, 2014

(54) Accurate Range Estimation System for Electrical Vehicles

(71) Applicant: Wilkes University, Wilkes-Barre, PA (US)

(72) Inventor: Zhang Xiaoli, Wilkes-Barre, PA (US)

(21) Appl. No.: 13/941,615

(22) Filed: Jul. 15, 2013

Related U.S. Application Data
(60) Provisional application No. 61/672,328, filed on Jul. 17, 2012.

(51) Int. Cl. B60L 11/18

(52) U.S. Cl. CPC B60L 11/1861
USPC 701/34.4

(57) ABSTRACT

A range estimation system for battery-powered vehicles which has a means for manually entering desired destination information, a processor, and a display. The system is capable of retrieving state-of-charge information from the vehicle's battery, is configured to obtain available road and terrain information regarding potential paths from the vehicles current location to the desired destination, and is configured to use said road and terrain information to compare said state-of-charge information to said desired destination and provide information to the user about whether the battery has sufficient charge to power the vehicle to the desired destination.

### CROSS-REFERENCE TO RELATED APPLICATIONS

This application claims priority under 35 U.S.C. §119(e)(1) from U.S. Provisional Patent Application No. 61/672,328, filed on Jul. 17, 2012, for “Accurate Range Estimation System For Electrical Vehicles,” the disclosure of which is incorporated herein by reference.

### STATEMENT REGARDING FEDERALLY SPONSORED RESEARCH

Not Applicable.

### BACKGROUND

1. Field of Invention

The present invention relates to electric vehicles. In particular, the present invention relates to a system for estimating the range available to a electric vehicle user based on the present charge of the vehicle's battery.

2. Description of Related Art

Electric vehicles, such as power wheelchairs, are powered by batteries. Batteries must be periodically recharged in order to continue to provide the mechanical power that drives the vehicle. In view of this, it is advantageous to provide a battery with a state of charge (“SOC”) indicator. Such an indicator would provide a visible or audible indication when the SOC of the battery has fallen below a predetermined threshold. The indication would inform a user of the low state of charge condition and the impending need to recharge the battery. The indication reduces the risk of discharging the battery to a level insufficient to provide usable power or to a level at which the electric vehicle will no longer operate.

Charge indicators are well known in the art. However, prior art charge indicators only adopt a battery fuel gauge to report the SOC of batteries based on battery models. While such indicators give users a rough estimate of how much “power is left” in the battery, they do not give any estimation of whether a user can successfully travel between designated locations without having to recharge the battery. Such estimation must take into account the terrain and distance the user will travel to arrive at the selected destination. There is therefor a need for a system that will allow a user of electric vehicle to accurately estimate whether his/her vehicle must be recharged before setting out to reach a desired destination.

### SUMMARY

The present invention is a system that enables an electric vehicle user to accurately estimate whether the current SOC of the vehicle's battery is sufficient to power the vehicle to a desired destination. Destination information is manually entered into the system by the user using, e.g., a handheld electronic device or personal computer. The system then retrieves SOC information from the battery and compares that information to the destination information provided by the user. Using available real-world road and terrain information obtained via electronic geography databases such as Geographical Information System (GIS) and Global Positioning Systems (GPS), the system calculates whether the battery's SOC is sufficient to power the vehicle to the desired destination. The calculation is then shown to the user, who will decide whether or not to recharge the battery before proceeding to the desired destination using the vehicle.

### BRIEF DESCRIPTION OF THE DRAWINGS

FIG. 1 is a flowchart illustrating the steps taken to implement an embodiment of the present invention.

### DETAILED DESCRIPTION

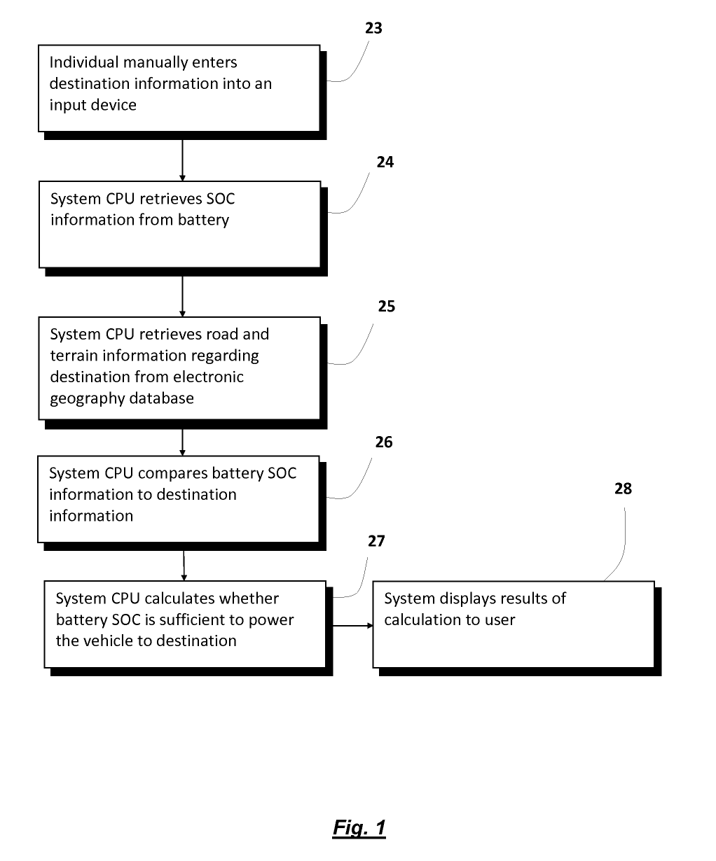

FIG. 1 is a flowchart illustrating a system that enables a electric vehicle user to accurately estimate whether the current SOC of the vehicle's battery is sufficient to power the vehicle to a desired destination. First, the user manually enters destination using a device capable of receiving such input 23 (i.e., a handheld device). A central processing unit (“CPU”) then retrieves SOC information from the battery 24 and retrieves real-world road and terrain information from an electronic geography database (e.g., an in-vehicle 3-D map or vehicle GPS-based navigation systems) 26. The CPU then compares 27 and calculates whether the battery's SOC is sufficient to power the vehicle to the desired destination 28. A user behavior model chooses a preferred path from an origin location to a desired destination, time to charge the battery, as well as the average speed and acceleration based on his/her habits. The power model of the vehicle converts terrain information of the preferred path into power consumption, and further combines it into the battery model to estimate the battery remaining capacity and to estimate the maximum distance based on the given driver behaviors including the initial SOC of the battery, the path from the origin location to the desired destination, and speed and acceleration that the user drives. This problem can be modeled by two submodels: runtime SOC as well as the final SOC at the destination.

The first model is the range SOC model in the equation below. Based on preview of road terrain, this model can accurately estimate the range SOC of a battery.

$$ϕ ( N ) = ϕ ( 0 ) - {\int }_{0}^{{\sum }_{i = 0}^{N} \frac{{l}_{i}}{{v}_{i} ( {h}_{i} , {C}_{t}^{r} )}} \frac{{P}_{i} ( {h}_{i} , {C}_{t}^{r} )}{η \cdot {V}_{t} ( {h}_{i} , {C}_{t}^{r} )} d t = {\sum }_{i = 0 , [ S , D ]}^{N} \frac{{P}_{i} ( {h}_{i} , {C}_{t}^{r} )}{η \cdot {V}_{i} ( {h}_{i} , {C}_{t}^{r} )} \cdot \frac{{l}_{i}}{{v}_{i} ( {h}_{i} , {C}_{t}^{r} )}$$

where, φ is the SOC of a battery. φ(0) and φ(N) are the initial SOC and final SOC when a vehicle drives from an origin location S to a desired destination D. Assuming that the total distance from the origin location S to the desired destination D is d, the total distance can be further divided into N segments with a length lᵢ (i=1 to N). For each segment, road terrain including elevation hᵢ rolling coefficient Cᵢ and speed vᵢ determines the power consumption Pᵢ(hᵢ, Cᵢ, vᵢ) and current draw Iᵢ(hᵢ, Cᵢ, vᵢ) as well as the output voltage (Vi(hi, Ci)) of the battery.

$${\int }_{0}^{{\sum }_{i = 0}^{N} \frac{{l}_{i}}{{v}_{i} ( {h}_{i} , {C}_{i} )}} \frac{{P}_{i} ( {h}_{i} , {C}_{i} )}{η \cdot {V}_{i} ( {h}_{i} , {C}_{i} )}$$

dt is the total consumed capacity to drive the vehicle from the origin location S to the desired destination D, and can be discretized to

$${\sum }_{i = 0}^{N} \frac{{P}_{i} ( {h}_{i} , {C}_{i} )}{η \cdot {V}_{i} ( {h}_{i} , {C}_{i} )} \cdot \frac{{l}_{i}}{{v}_{i} ( {h}_{i} , {C}_{i} )} .$$

Based on the range SOC estimation, the second model in the equation below is to estimate the maximization of the total distance for range estimation based on the initial SOC of the battery.

$$R = max {\sum }_{i = 0 [ S , D ]}^{N} {l}_{i} ( {h}_{i} , {C}_{t}^{r} )$$

$$Subject to \text{:}$$

$$\{ \begin{matrix}{V}_{i} ( {h}_{i} , {C}_{t}^{r} ) \geq {V}_{c} \\ {v}_{i} ( {h}_{i} {C}_{t}^{r} ) \geq {v}_{max} \\ {a}_{i} ( {h}_{i} , {C}_{t}^{r} ) \leq {a}_{max}\end{matrix}$$

where, V_{c} is the cutoff voltage of battery. Vₘₐₓ, and αₘₐₓ are the maximum speed and acceleration of the battery-powered vehicle, respectively.

The terrain of a road is mainly characterized by two factors: elevation profile and rolling coefficient. The road elevation profile of a particular path can be directly obtained through a 3D map, such as Google Earth, on board GPS and GIS systems, and other professional 3D map software. For a given road elevation profile of a path, the grade angle of a road can be denoted as in the equation below.

$$α ( l ) = asin ( \frac{d h ( l )}{d l} )$$

where, a(l) is the grade angle of a road. h(l) is the elevation profile of a road. l is a distance from an original location to a destination. The road grade angle can be further denoted as a desecrate format in the equation below.

$${α}_{i} = asin ( \frac{{h}_{i + 1} - {h}_{i}}{{l}_{i + 1} - {l}_{i}} )$$

where, αᵢ is the grade angle of a road at the distance lᵢ with elevation hᵢ.

The rolling coefficient of a road is mainly caused by deformation of tires, deformation of road surface, or both. Additional contributing factors include wheel radius, forward speed, surface adhesion, and relative micro-sliding between the surfaces of contact.

Based on the mechanical forces acting on vehicles, the power consumption is determined in the equation below by the acceleration of a vehicle

$$( \frac{d v}{d t} ) ,$$

the speed v, the road grade angle (α), its total mass (M), the aerodynamic drag coefficient (C_{α}), the vehicle front surface including driver (S), the rolling coefficient (Cᵣ), and the driven train efficiency (η).

$${P}_{e} = \frac{v}{η} ( M \frac{d v}{d t} + 0.5 ρ {v}^{2} {SC}_{a} + Mg sin α + {MgC}_{r} cos α )$$

where, g is the gravity of the Earth. ρ is the density of air. For given origin locations and destinations, rolling coefficient and road grade can be directly derived from the map.

A battery is not an ideal energy source. The available energy of the battery varies with the profile of a battery powered load. Specifically, the battery tends to have a low energy at a high discharge current rate. The reduced battery energy is not physically lost and can be recovered after the battery has some rest. Temperature also has a nonlinear impact on the internal resistance, open circuit voltage, and battery capacity. The battery voltage is also nonlinear, and is decreased with the depth of discharge.

In this circuit based battery model, voltage and capacity of the capacitor C_{b} is battery open-circuit voltage and capacity respectively. R is an ohmic internal resistance, which is used to capture battery voltage response at constant current. A RC network Rₜ and Cₜ denotes a voltage transient response at a pulse load. Each component in this circuit model can be modeled as is the equation below.

$$\{ \begin{matrix}ϕ = \frac{{c}_{f} - {I}_{t}}{{c}_{f}} \\ {V}_{oc} = k ϕ \\ R = {a}_{1} {I}^{{a}_{2}} \\ {R}_{t} = {b}_{1} {I}^{{b}_{2}} ( {b}_{3} + {b}_{4} {V}_{oc} + {b}_{5} {V}_{oc}^{2} ) \\ {R}_{t} {C}_{t} = {d}_{1} {I}^{{d}_{2}}\end{matrix}$$

where, φ denotes SOC. c_{ƒ}, is the full capacity. Iₜ is the total consumed energy with a current of I at the time length of t. a₁ and a₂, b₁-b₅, and d₁ and d₂ are coefficients of the component model, and can be derived through data fitting methods by experimental data of the battery.

Once the battery sufficiency has been calculated, the system displays the calculation results to the user 28. The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A system for estimating the range available to a battery-powered vehicle, said system comprising:
(a) a device for manually entering desired destination information;
(b) a processor configured to retrieve state-of-charge information from said vehicle's battery, configured to obtain available road and terrain information, and configured to use said road and terrain information to compare said state-of-charge information to said desired destination; and
(c) a display capable of showing the results of said comparison to the user.
